(19) United States
(12) Patent Application Publication
(10) Pub. No.: US 2025/0239874 A1
(43) Pub. Date: Jul. 24, 2025

(54) LOW VOLTAGE POWER SUPPLY SYSTEM AND METHOD

(71) Applicant: ECO DESIGN GROUP LLC, Middletown, NJ (US)

(72) Inventors: Leonardo Estrella, Middletown, NJ (US); Amir-Reza Bazargan-Lari, Brooklyn, NY (US)

(21) Appl. No.: 19/035,008

(22) Filed: Jan. 23, 2025

Related U.S. Application Data
(60) Provisional application No. 63/623,967, filed on Jan. 23, 2024.

(51) Int. Cl. H02J 7/00

(52) U.S. Cl. CPC H02J 7/0071; H02J 7/00036; H02J 7/0013; H02J 7/00712; H02J 2207/20

(57) ABSTRACT

A power supply system supplies power to a plurality of power consuming devices via a single, low voltage supply line that has a maximum power rating. An energy storage device is linked to each of the power consuming devices, and the associated energy storage device is the exclusive source of power to the power consuming device. The energy storage devices are charged in accordance with a schedule so that all of the energy storage devices in a branch circuit are kept sufficiently charged to power their associated power consuming devices without the low voltage supply line ever exceeding its maximum power rating.

### CROSS-REFERENCE TO RELATED APPLICATIONS

This application claims priority to Prov. Pat. App. Ser. No. 63/623,967, filed on 2024 Jan. 23, the entire contents of which are expressly incorporated herein by reference.

### BACKGROUND

The present disclosure relates to a system and method for powering multiple devices, And more particularly to a low voltage power supply system.

Solar heat from sunlight incursion through windows can substantially affect temperature management within a corresponding building. Window shades can regulate the solar heating effect so as to help buildings consume less energy to power heating and cooling systems. Although some window shades can be adjusted by a user, the sun's position relative to the window changes throughout the day. Automated, motorized window shades that automatically adjust to such changes without relying on user control have proven effective in adjusting the window shades to most effectively regulate solar heat absorption.

Motorized window shades, However, require a source of electrical power. In a building with multiple motorized window shades, electric wiring using standard class 1 power (i.e., 120 VAC line voltage) that must comply with stringent safety standards. Also, installation of class 1 electrical wiring requires a licensed electrician. The associated expense can make wiring such motorized window shades prohibitively expensive.

Low voltage power systems can be used to power devices such as window shade motors. For example. Power-over-ethernet (POE) systems enable devices to be powered by low voltage class 2 wiring that can be installed without requiring a licensed electrician. However, such low voltage power systems have power supply limits that severely limit the number and type of power consuming devices that can be so powered.

### SUMMARY

The present specification discloses a power supply system that supplies low voltage power to a plurality of power consuming devices via a single, low voltage supply line that has a maximum power rating. Installation of the low voltage supply line does not require a licensed electrician. An energy storage device, such as a battery, is linked to each of the power consuming devices, and the associated energy storage device is the exclusive source of power to the power consuming device. The energy storage devices are all configured in a single branch circuit to which low voltage power is supplied by the low voltage supply line. The energy storage devices are charged in accordance with any of various methods such as a time schedule so that all of the energy storage devices in the branch circuit are kept sufficiently charged to power their associated power consuming devices without the low voltage supply line ever exceeding its maximum power rating.

In accordance with one embodiment, the present specification provides a power supply system, comprising a low voltage power supply configured to supply low voltage power to a branch circuit via a single low voltage supply line, the low voltage supply line having a maximum power rating. The branch circuit comprises a plurality of energy storage devices, each of which is electrically connected to a corresponding power consuming device and configured to be an exclusive power source of the corresponding power consuming device. Each of the plurality of energy storage devices is configured to receive charging power exclusively from the low voltage supply line. The system is configured to charge each of the plurality of energy storage devices according to a charging schedule so that the power flowing through the low voltage supply line never exceeds the maximum power rating.

Some variations additionally comprise a plurality of energy storage device controllers configured to selectively connect and disconnect an associated one of the plurality of energy storage devices from the low voltage supply line so as to control charging of the associated one of the plurality of energy storage devices. Energy storage device controllers can be incorporated into an energy storage device such as a battery, but can also be disposed in other structural components but configured to provide connect and disconnect control of an associated energy storage device

Further variations additionally comprise a main controller configured to direct control of the plurality of energy storage device controllers according to the charging schedule. In some such variations, the main controller is configured to communicate data to and from the plurality of energy storage device controllers over the low voltage power supply line.

In further variations the main controller is configured to receive an energy storage device state data from each of the plurality of energy storage device controllers and save the energy storage device state data in memory, and the main controller is configured to modify the charge schedule in consideration of the energy storage device state data.

In still further variations, the main controller can be configured to communicate with a grid computer so as to obtain information about a state of an electric grid.

In yet other variations each of the plurality of power consuming devices has an operating power requirement, and a combination of the operating power requirements of all of the plurality of power consuming devices exceeds the maximum power rating of the low voltage supply line.

In additional variations, the low voltage power supply is configured to receive an input power from a primary power supply, and the low voltage power supply comprises a power conditioner configured to transform the input power to the low voltage power. The primary power supply can be a line voltage, or can be from another source such as a localized solar, wind, or hydroelectric source, and can be from a localized energy storage device source.

Still additional variations can additionally comprise a power interface interposed between the low voltage supply line and each of the plurality of energy storage devices. The power interface can comprise an interface conditioner configured to transform the low voltage power into a final power for delivery to the associated one of the plurality of energy storage devices.

In accordance with another embodiment, the present specification provides a method of supplying the power needs of a plurality of power consuming devices. The method comprises providing a power distributor comprising a low voltage power supply and providing a branch circuit comprising first through nth energy storage devices. The letter n refers to a total number of energy storage devices in the branch circuit. Each of the first through nth energy storage devices is electrically coupled with a respective first through nth power consuming device so that each of the first through nth energy storage devices exclusively powers the respective first through nth power consuming device. The method further includes connecting the power distributor to the first through nth energy storage devices in the branch circuit via a low voltage supply line, which low voltage supply line has a maximum power rating. The method further includes charging the first through nth energy storage devices according to a schedule so that the power communicated through the low voltage supply line never exceeds the maximum power rating.

In some variations each of the first through nth power consuming devices has a power consumption rating, and the sum of the power consumption ratings of the first through nth power consuming devices exceeds the maximum power rating of the supply line.

In additional variations, the power distributor comprises a distributor controller, and the method further includes the distributor controller sending control signals over the low voltage supply line to selectively supply electric power to charge a selected one of the first through nth energy storage devices. In some such variations, the distributor controller has a charging schedule stored in a memory, and the control signals are configured to execute the charging schedule.

In some variations a first secondary controller directs a port be opened so that the first energy storage device is in electric communication with the low voltage supply line, and the first secondary controller directs the port be closed so that the first energy storage device is cut off from electric communication with the low voltage supply line. Some such variations comprise the first secondary controller receiving control signals from the distributor controller via the low voltage supply line. Still further variations comprise the first secondary controller receiving a data concerning a state of the first energy storage device and communicating the data concerning the state of the first energy storage device to the distributor controller.

Some variations comprise the distributor controller receiving a data concerning a state of each of the first through nth energy storage devices, and the distributor controller developing a charging schedule using the data concerning the state of each of the first through nth energy storage devices.

Still further variations can comprise the distributor controller receiving a grid data concerning a state of an electric grid, and the distributor controller determining when to execute the charging schedule based at least in part on the grid data.

### BRIEF DESCRIPTION OF THE DRAWINGS

FIG. 1 is a schematic representation of a power delivery system configured in accordance with one embodiment.

FIG. 2 is a schematic representation of a power delivery system configured in accordance with another embodiment; and

FIG. 3 is a schematic representation of a power delivery system configured in accordance with yet another embodiment.

### DESCRIPTION

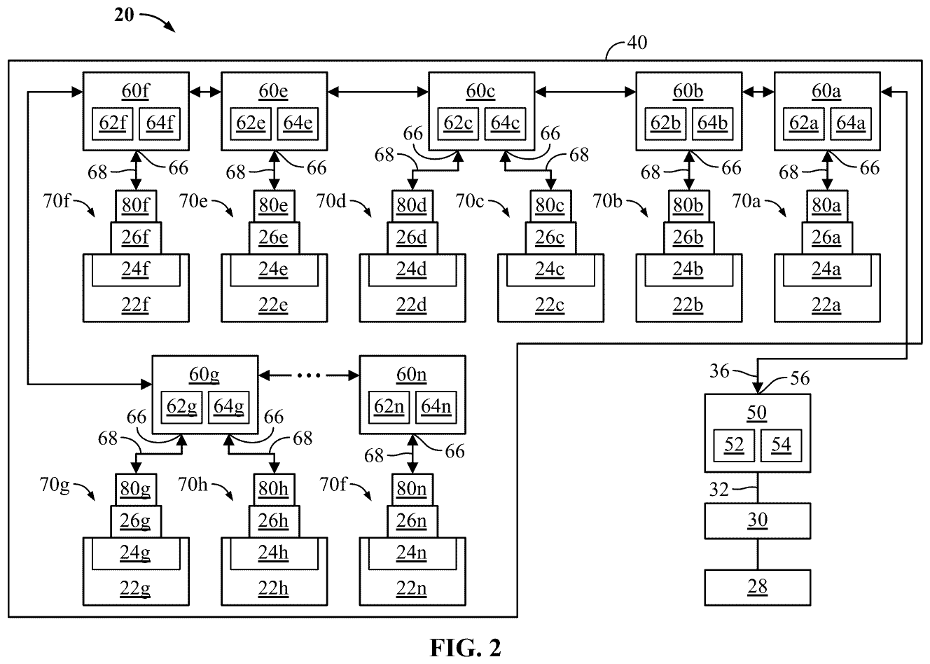

The present specification discloses a power supply system that supplies low voltage power to a plurality of power consuming devices via a single, low voltage supply line that has a maximum power rating. The low voltage supply line and associated electrical equipment meets National Electrical Code (NEC) class 2 requirements by inherently not posing a fire risk, and can be installed without requiring a licensed electrician. As depicted in FIG. 2, and as will be discussed in more detail below, an energy storage device 80, such as a battery, supercapacitor, other device or system for storing electrical energy, or combination of one or more of same, is linked to each of the power consuming devices 70, and the associated energy storage device 80 supplies power to the power consuming device 70. Several energy storage devices 80a-n are all configured in a single branch circuit 40 to which low voltage power is supplied by the low voltage supply line 36. The energy storage devices 80a-n are charged in accordance with a charging control logic, such as a schedule, so that all of the energy storage devices 80a-n in the branch circuit 40 are kept sufficiently charged to power their associated power consuming devices 70a-n without the low voltage supply line 36 ever exceeding its maximum power rating. A controller 54 can calculate the charging schedule and can direct other controllers 64 to selectively charge selected energy storage devices 80a-n in turn. Data can be communicated over the low voltage supply line 36 both to communicate controls in accordance with the charging schedule and to receive data concerning energy storage devices state so that the controller 54 can modify the schedule.

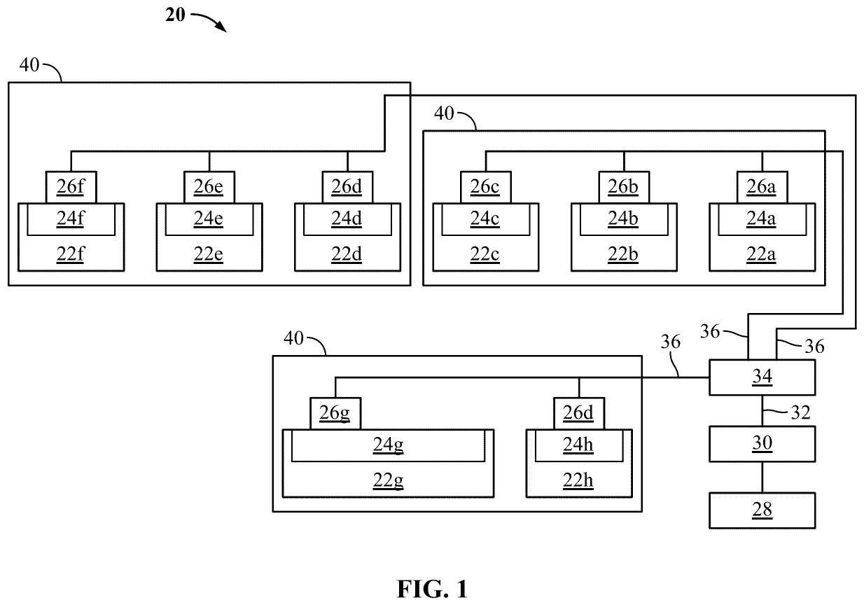

With reference now to FIG. 1, a schematic representation of a low voltage power supply system. 20 is shown. This embodiment schematically depicts several windows 22a-h, each of which includes a window shade 24a-h powered by a respective motor 26a-h. Each motor 26a-h is configured to adjust the corresponding window shade 24a-h up, down, and, in some variations, can adjust the angle of slats, if relevant.

In the illustrated example, a power supply 28, such as line voltage (typically 120 VAC) supplies electric power to a circuit breaker 30. An output conductor 32 of the circuit breaker 30 supplies the line voltage to a low voltage power supply 34, such as a class 2 power supply, which is configured to receive the input line voltage and condition it to output a filtered, low voltage, class 2 power supply. In the US, class 2 power is defined by the National Electric Code (NEC) as less than 60V and having total power in each supply line 36 of less than 100 W. In this specification, the class 2 limitations are referred to as low voltage. It is to be understood that in different jurisdictions, or over time, the specific voltage and power numbers that define low voltage can vary. For purposes of this specification, and in addition or in lieu of specified class 2 power definitions, low voltage is intended to refer to circuits that are considered safe from a fire and shock initiation standpoint due to limitations of voltage and/or power output.

In the present example, each motor 26a-h is a DC motor rated to require 16 W nominal power to operate, and 32 W at startup, as is currently expected for motors used in window shade systems. As such, in order to comply with the low voltage power requirement of less than 100 W, the supply line 36 can supply power to no more than three motors 26a-h at a time. Thus, a plurality of branch circuits 40 are defined, with each branch circuit 40 having 3 motors 26 and being supplied power from a dedicated supply line 36. The portion of each supply line 36 extending from the branch circuit 40 to the low voltage power supply 34 can be referred to as a “home run”. As shown, the low voltage power supply 34 has a plurality of outlets so as to supply a corresponding plurality of supply line 36 home runs, each providing power to motors 26a-h in a corresponding branch circuit 4-0. Further, in this embodiment an array of many motors 26 will require several home runs, as well as a complex low voltage power supply 34 capable of powering several branch circuits 40 simultaneously.

With reference next to FIG. 2, another embodiment is illustrated. In this embodiment, the primary power supply 28 feeds line voltage (12 VAC) to a circuit breaker 30, which in turn feeds the line voltage to a power distributor 50 that includes a low voltage distributor power conditioner 52 configured to convert the AC line voltage into a low voltage DC output power such as 48 VDC. The illustrated power distributor 50 also includes a distributor controller 54 that comprises computing ability, including a processor, memory and the like. The power distributor 50 provides one or more low voltage ports 56, to which a supply line 36 can be attached. The supply line 36 can be any conductor suitable for conducting low voltage class 2 power. In a preferred embodiment the supply line 36 is configured to conduct both power and data. For example, the supply line can comprise cable commonly known as category 5 (“Cat5”) or category 6 (“Cat6”). While such cable can be hard wired to various ports, more preferably the supply line 36 comprises quick-connect connectors such as RJ-45 connectors. Similarly, the low voltage ports 56 can be configured to accept such RJ-45 connectors so that each supply line 36 can be readily connected to components by a non-electrician (i.e., an individual who is not a licensed electrician licensed to work with class 1, non-low voltage circuits).

The supply line 36 delivers low voltage power from the power distributor 50 to a power interface 60a which, in the illustrated embodiment, can comprise an interface power conditioner 62a and an interface controller 64a. The interface power conditioner 62a can further condition the power. For example, the illustrated interface conditioner 62a can transform the 48 VDC power supplied to the power interface 60a via the supply line 36 into a 24 VDC power that is supplied to an interface port 66.

Continuing with reference to FIG. 2, a local line 68 can connect to port 66 so as to communicate such 24 VDC power to a power consuming device 70a which, in the illustrated embodiment, can comprise a motor 26a. The motor 26a is connected to an energy storage device 80a, which can be external to the motor 26a or, in some variations, can be incorporated into the motor 26a. The energy storage device 80a can be a battery, supercapacitor, other structure configured to store electric energy, or combinations of such. The motor 26a in FIG. 2 is configured to power an associated window shade 24a that is coupled with a window 22a. The local line 68 can be made of the same cable as the supply line 36. In some variations, however, the local line 68 can be optimized for shorter distances, ease of use, and low expense. For example, the local line 68 can be a wire in compliance with the USB-C standard, including connectors enabling easy connection to the interface port 66 and a port of the power consuming device 70a. The local line 68 can enable communication of both electric power and data between the power interface 60a and the power consuming device 70a.

In the illustrated embodiment, the motor 26a of the power consuming device 70a is configured to be powered solely by the associated energy storage device 80a, and the energy storage device 80a is selected and rated to meet the power needs of the motor 26a. Thus, power from the distributor 50 is delivered to the energy storage device 80a rather than directly to the motor 26a. The energy storage device 80a is configured to be charged by low voltage power from the power distributor 50 delivered via the power interface 60a.

As shown in FIG. 2, another power interface 60b is electrically connected to power interface 60a via a supply line 36 so that the output power of the power distributor 50 passes through power interface 60a to power interface 60b. Similarly, any number of power interfaces 60a-n can be so interconnected so that low voltage power from the power distributor 50 can be delivered to each power interface 60a-n. Notably, the letter “n” is used herein as a variable to represent any number, such as the “nth” power interface 60. Each power interface 60a-n can be configured with an associated interface power conditioner 62a-n and interface controller 64a-n and can be configured to provide power to a corresponding power consuming device 70a-n, which device can be linked to a respective energy storage device 80a and may comprise a motor 26a-n.

In the window shade-oriented example illustrated in FIG. 2, the motors 26a-n are, like those in FIG. 1, rated to use 32 W during startup. Thus, due to the 100 W constraint for power delivery along the supply line 36, power distributor 50 and supply line 36 are not capable of powering all of the motors 26a-n at the same time. However, the illustrated power consuming devices 70a-n are configured so that each motor 26a-n can be entirely powered by the associated energy storage device 80a-n without requiring any real-time power delivery from the supply line 36. Thus, the power delivery system 20 operates to charge the energy storage devices 80a-n rather than to directly power the associated motors 26a-n. For example, when all of the energy storage devices 80a-n are charged, every one of the motors 26a-n can operate simultaneously without requiring any real-time power delivery via the supply line 36.

In one variation, the power delivery system 20 is configured to charge individual energy storage devices 80a-n according to a schedule that is independent of when the associated motors 26a-n are actually in use. Further, as desired, power use times for the system 20 can be customized as desired. For example, the system can be configured so that the power distributor 50 only provides energy to charge energy storage devices at off-peak electric grid use periods, such as at night. For example, energy storage devices 80a and 80b can be scheduled to charge on day 1, with charging of energy storage device taking place from 11 pm-2 am and charging of energy storage device 80b taking place from 2 am-5 am. Energy storage devices 80c and 80d can then be scheduled to charge the next night, and so on until energy storage device 80n is charged, after which the schedule can repeat.

The schedule can be developed in consideration of the expected power consumption of each power consuming device 70a-n and energy storage device charge needs. For example, in the illustrated variation a typical motor 25a-n for driving a window shade 24 can be coupled with a typical energy storage device, such as a lithium-ion energy storage device storing about 50 Wh. In such a configuration, the energy storage device 80a-n can be expected to give 6-12 months of use before being drained, and thus needs to be recharged at most every 6 months. Given current energy storage device charging technology, each energy storage device 80a-n can be charged via a standard charge procedure within 3 hours, and 1 hour with rapid charging. n this example, in which only two energy storage devices are charged each day-albeit at off-peak hours—the system 20 can charge 365 energy storage devices in each six-month period. Thus, in this example, the single home run supply line 36 can support the power needs of 3656 window shade motors 26a-n while charging only at off-peak grid times.

Implementation of a charging schedule can be accomplished via the distributor controller 54 and interface controllers 64a-n working in concert. The interface controllers 64a-n preferably are configured to control when the associated interface port 66 is energized. In one example, the distributor controller 54 can send a data signal directing interface controller 64a to energize its associated port 66 so as to commence charging of energy storage device 80a, and similarly can send a data signal directing interface controller 64a to de-energize the associated port 66 when scheduled charging is completed. Such instruction can be communicated to each other interface controller 64b-n in turn. Of course, the particulars of control instructions can vary in different variations. For example, in another variation, the schedule is downloaded to a memory of each of the interface controllers 64a-n. As such, each controller 64a-n independently follows the schedule in controlling its corresponding interface port 66 rather than waiting for specific control signals from the distributor controller 54. In still further variations the schedule, including associated operational programming and control logic, can be held in a memory of any controller that can be part of the power consuming device 60a-n, such as a standalone controller and/or a controller that is part and/or linked to a motor 26a-n, energy storage device 80a-n or the like.

In still further embodiments, energy storage device data, such as charge status- or state, can periodically be communicated from the energy storage device 80 to the corresponding interface controller 64, which in turn can communicate such data to the distributor controller 54. The distributor controller 54 can save the energy storage device data of each of the energy storage devices 80a-n of its branch circuit 40. The saved energy storage device data can be used by the distributor controller 54 to modify an existing schedule based on the needs of individual energy storage devices and/or to develop a charging schedule based on which energy storage devices are most in need of charging. Also, when an energy storage device 80 is being charged, it can update its charging status more often, or even continuously. Thus, if an energy storage device 80 achieves full charge before completing its scheduled charging time, the charging schedule can be modified to move on to the next energy storage device 80 earlier than initially schedule, and vice versa.

In still further variations, historical charge and power usage data for each power consuming device 70a-n, which may be derived from energy storage device data, can be stored in memory and used by the distributor controller 54 to predict power needs of particular energy storage devices and direct the charging schedule to be modified or created so that the energy storage devices are charged sufficiently that enough stored power is available to meet needs. For example, if due to position or other factors, power consuming device 70a typically consumes twice as much power as power consuming device 70f, the schedule can be modified to charge energy storage device 80a more often than energy storage device 80f. Further, the charge control logic or schedule can be developed ad hoc based on sensed power needs, so that charging is directed to the power consuming device(s) 70a-n detected to have the greatest need for charging, either based on charge status alone or in concert with anticipated need in view of historical use or the like. Thus, the charging schedule- or control logic—can be developed, changed, updated and the like in real-time. Still further, charging can be triggered by use, such as charging for a particular energy storage device 80a-n can become prioritized after a certain number of operational uses, or cycles, of the associated motor 26a-n and/or a certain time period of operational use of such motor 26a-n.

Continuing with reference to FIG. 2, variations can include situations in which each power consuming device 70a-n has a dedicated power interface 60a-n, as in power consuming devices 70a, 70b,70e, 70f and 70n. However, as shown, in some variations a single power interface 60c can connect to two or more power consuming devices 70c, 70d. Power interface 60c can be configured similar to other power interfaces 60, but controls two interface ports 66—one connected to power consuming device 70c and one connected to power consuming device 70d. Also, the system can be used with different configurations. For example, window 22g as depicted in FIG. 2 is larger than other typical windows 22a-f, n, and as a result its window shade 24g is powered by two motors 26g, 26h, which can be controlled by and charged via a single power interface 60g. Additionally, although each power consuming device 70a-n has been illustrated schematically having a single energy storage device 80a-n and single motor 26n, it is to be understood that each power consuming device 70a-n can be configured as a network or array of multiple such structures. For example, a single energy storage device can be dedicated to two or more motors, or vice versa.

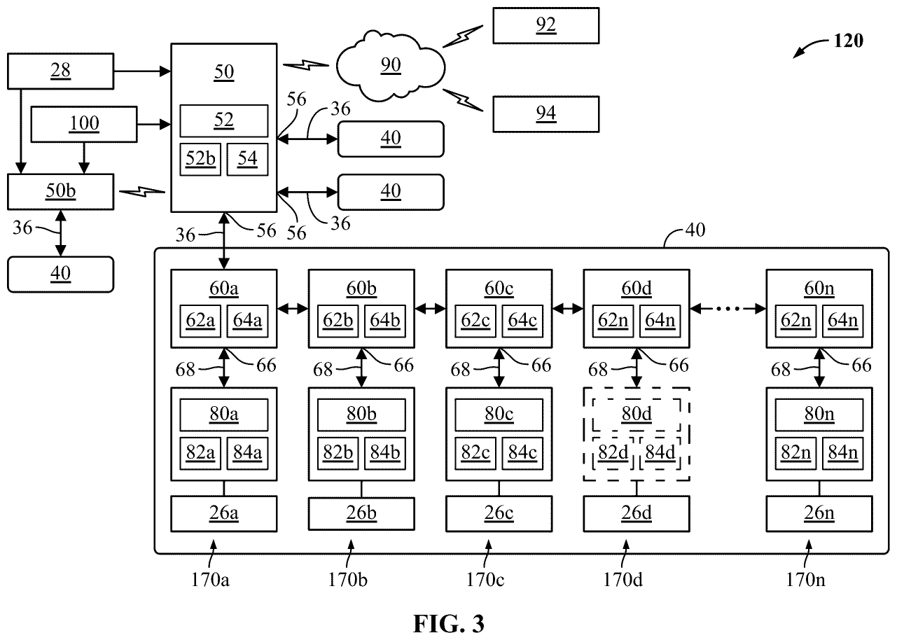

The power delivery systems 20 depicted in FIGS. 1 and 2 are configured to provide power for a system of automatic window shades 24a-n, in which each power consuming device 70a-n comprises a motor 26a-n expected to have similar power requirements as other motors 26a-h in the system 20. However, it is to be understood that more complex systems are anticipated. With reference next to FIG. 3, another embodiment of a low voltage power delivery system 120 also supplies low voltage power to a plurality of power consuming devices 170a-n. As shown, a primary power supply 28, such as a line voltage, supplies 120 VAC or 240 VAC class 1 power to a circuit breaker 30, which passes along such power to power distributor 50. As in the embodiment above, the power distributor 50 has a low voltage power conditioner 52 to filter and transform the input power to a low-voltage, class 2 power, such as 57 VDC, 48 VDC, or the like. Also a low voltage supply line 36 communicates such low voltage power to a branch circuit 40 made up of a plurality of power interfaces 60a-n that in turn supply power to energy storage devices 80a-n of power consuming devices 170a-n. The low voltage supply line 36 is also capable of communicating data to and from a distributor controller 54 within the power distributor 50.

In variations represented by FIG. 3, each of the power consuming devices 170a-n can be any of several different types of devices having differing power needs. For example, power consuming devices 170a-n can include various devices such as LED-based luminaires and/or groups of LED-based luminaires, audio equipment, televisions, wall clocks, electrical appliances such as dishwashers or microwave ovens, an electric can opener, telephone charging stations, computers, other office equipment, motorized window shades or any of many other electric-powered power consuming devices 170a-n, and a branch circuit 40 can include multiple different types of power consuming devices 170a-n.

The power consuming devices 170a-n can be linked with an energy storage device 80a-n, which energy storage device may, in some variations, be linked to its own dedicated energy storage device power conditioner 82a-n and energy storage device controller 84a-n. In most cases, some type of electrical motor 26a-n (or motors) will be linked to the energy storage device 80a-n, and the energy storage device 80a-n and motor 26a-n—or in some instances a plurality of energy storage devices 80a-n and motors 26-n—can be enclosed together within a single housing and/or as a preconstructed unit. In some cases, such as if a power consuming device 170a-n is a charging station, a motor 26a-n may not be present. As just noted, one or more of the power consuming devices 170a-n can be a charging station or other type of energy storage device, including an energy storage device with sufficient capacity to act as a secondary power source 100, as will be discussed below.

In the illustrated variation, each power interface 60a-n includes an interface power conditioner 62a-n, which can further condition power received from the supply line 36 to better match the requirements of the associated power conditioning device 170a-n. For example, 48V power may be provided by the supply line 36, but motor 26b may require only 5V, and thus interface power conditioner 62b may transform the 48V power to 5V for delivery to the motor 26b. It is to be understood that, in some embodiments, an interface power conditioner 62a-n can be dispensed with if no conditioning further than that provided by the power distributor conditioner 52 is desired, or if, for example, an energy storage device power conditioner 82a-n is present. Further, the energy storage device controller 84 may handle communication with the distributor controller 54 and may also control energizing of charging power delivery to the associated energy storage device 80a-n rather than any interface controller 64a-n performing such control.

With continued reference to FIG. 3, the power consuming devices 170a-n are arranged in a branch circuit 40 to which power from the power distributor 50 is provided by a single home run of a low voltage supply line 36. As such, the total power delivered to the branch circuit 40 at any one time must comply with low voltage specifications (such as less than 60 VDC and less than 100 W). In this variation, the distributor controller 54 receives and stores energy storage device data from the energy storage device controllers 84a-n, and also stores data concerning the anticipated power needs of each power consuming device 170a-n. Such data about anticipated power needs can include not only the rated power consumption of the power consuming device 170a-n, but also historical use information derived from saved historical power use data, and even information predicting times when such device may be used. Armed with such data, the distributor controller 54 directs charging of the energy storage devices 80a-n, assigning appropriate priority to the greatest need, determining whether, and to what extent, charging can be delayed until off-peak nighttime hours, and preferably optimizing the charging process so as to detect when an energy storage device has completed the charging process so as to avoid overcharging and avoid wasting charging time. Actual, real-time use of the power consuming devices 170a-n will be powered by the associated energy storage device 80a-n, and will be independent of whether and which of the energy storage devices 80a-n is/are currently being charged. In some variations, however, the distributor controller 545 can detect that a particular one of the power consuming devices 170a-n in current, real-time use, is approaching energy storage device depletion, and thus has an additional power need. The distributor controller 54 can then direct emergency charging of the associated energy storage device 80 to assist with meeting power requirements. In still other variations, an energy storage device 80d may be optional in connection with one or more of the power consuming devices 170d, as shown in FIG. 3. Thus, power is delivered in real-time from the power interface 60d to the power consuming device 170d instead of via any energy storage device 80. In such a case the charging control logic will adjust charge control of energy storage devices 80a-c, n in the branch circuit 40 so that the total power flowing through the low voltage supply line 36 never exceeds the maximum power rating.

With continued reference to FIG. 3, in some variations the distributor controller 54 may include Wi-Fi, mobile or other internet-enabled technology enabling it to communicate over a network, such as the internet 90, with external computing devices such as a grid management computer 92 and/or administrator computer 94. A grid management computer 92 can communicate data such as the current or anticipated condition of the power grid, which data the distributor controller 54 can use in optimizing its charge scheduling in order to use off-peak hours and/or to optimize use of power generated by clean-energy sources. Also, during power emergencies, the grid management computer 92 can signal the distributor controller 54 to suspend charging activities in order to make more power available to satisfy more urgent needs. Similarly, an administrator computer 94, controlled by, for example, a building administrator, tenant, monitoring company, homeowner, or the like, can access the distributor controller 54 to override and/or further direct charging scheduling.

In some variations, a power distributor 50 can receive input power from a secondary power source 100, such as an on-building solar power installation. Such secondary power source 100 may provide power in a different form than the line voltage provided by the primary power source 28. For example, some solar systems provide power in a form that meets class 2 regulations, such as 48 VDC. In the illustrated embodiment, the power distributor 50 can have a second power conditioner 52b configured to receive and condition power from the secondary power source 100 if needed. Of course, in still other variations, a secondary or primary power source can take other forms, such as a centralized energy storage device system, localized wind or hydroelectric generators, or the like.

FIG. 3 also depicts another variation, in which the power distributor 50 is configured with multiple outlets 56, each of which is configured to communicate power conforming to low voltage configurations. In essence, the power distributor 50 would act as if it were multiple power distributors 50 acting in concert, and each outlet 56 would have a home run of a low voltage supply line 36 supplying power to a branch circuit 40 comprising a plurality of power consuming devices.

Still further, another variation may include a second power distributor 50b that receives power from the same primary and/or secondary power sources 28, 100 and supplies low voltage power to one or more associated branch circuits 40. For example, in a multi-story building, each floor may have its own dedicated power distributor 50, while each power distributor receives power from the same, or a mixture of, primary and secondary sources 28, 100. In yet further variations, the distributor controllers 52 of the power distributors 50, 50b can be configured to wirelessly or otherwise communicate data to one another and collaborate in developing charging schedules- or charging control logic, such as to manage how to deal with any limitations or regulations that may exist concerning use of power in the particular system 120. Wireless communication can also be contemplated with other controllers, such as interface controllers 64a-n, energy storage device controllers 84a-n or others as the case may be.

The embodiments and variations discussed above have disclosed structures and methods with substantial specificity. This has provided a good context for disclosing and discussing inventive subject matter. However, it is to be understood that other embodiments and variations may employ different specific structural shapes and interactions.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above.

What is claimed is:

1. A power supply system, comprising:
a low voltage power supply configured to supply a low voltage power to a branch circuit via a single low voltage supply line, the low voltage supply line having a maximum power rating;
the branch circuit comprising a plurality of energy storage devices, each energy storage device electrically connected to a corresponding power consuming device and configured to be a power source of the corresponding power consuming device, each of the plurality of energy storage devices configured to receive charging power exclusively from the low voltage supply line;
wherein the system is configured to charge each of the plurality of energy storage devices according to a charging schedule so that the power flowing through the low voltage supply line never exceeds the maximum power rating.

2. The power supply system of claim 1, additionally comprising a plurality of energy storage device controllers configured to control power delivery to an associated one of the plurality of energy storage devices from the low voltage supply line so as to control charging of the associated one of the plurality of energy storage devices.

3. The power supply system of claim 2, additionally comprising a main controller configured to direct control of the plurality of energy storage device controllers according to the charging schedule.

4. The power supply system of claim 3, wherein the main controller is configured to communicate data to and from the plurality of energy storage device controllers over the low voltage power supply line.

5. The power supply system of claim 4, wherein the main controller is configured to receive a energy storage device state data from each of the plurality of energy storage device controllers and save the energy storage device state data in memory, and wherein the main controller is configured to modify the charge schedule in consideration of the energy storage device state data.

6. The power supply system of claim 5, wherein the main controller is configured to communicate with a grid computer so as to obtain information about a state of an electric grid.

7. The power supply system of claim 2, wherein each of the plurality of power consuming devices has an operating power requirement, and wherein a combination of the operating power requirement of all of the plurality of power consuming devices exceeds the maximum power rating of the low voltage supply line.

8. The power supply system of claim 2, wherein the low voltage power supply is configured to receive an input power from a primary power supply, and the low voltage power supply comprises a power conditioner configured to transform the input power to the low voltage power.

9. The power supply system of claim 8, additionally comprising a power interface interposed between the low voltage supply line and each of the plurality of energy storage devices, wherein the power interface comprises an interface conditioner configured to transform the low voltage power into a final power for delivery to the associated one of the plurality of energy storage devices.

10. A method of supplying the power needs of a plurality of power consuming devices, the method comprising:
providing a power distributor comprising a low voltage power supply;
providing a branch circuit comprising first through nth energy storage devices, wherein n refers to a total number of energy storage devices in the branch circuit, and wherein each of the first through nth energy storage devices is electrically coupled with a respective first through nth power consuming device so that each of the first through nth energy storage devices exclusively powers the respective first through nth power consuming device;
connecting the power distributor to the first through nth energy storage devices in the branch circuit via a low voltage supply line, the low voltage supply line having a maximum power rating; and
charging the first through nth energy storage devices according to a charge control logic so that the power delivered through the low voltage supply line never exceeds the maximum power rating.

11. The method of claim 10, wherein each of the first through nth power consuming devices has a power consumption rating, and wherein the sum of the power consumption ratings of the first through nth power consuming devices exceeds the maximum power rating of the supply line.

12. The method of claim 10, wherein the power distributor comprises a distributor controller, and comprising the distributor controller sending control signals over the low voltage supply line to selectively supply electric power to charge a selected one of the first through nth energy storage devices.

13. The method of claim 12, comprising the distributor controller having a charging schedule stored in a memory, wherein the control signals are configured to execute the charging schedule.

14. The method of claim 12, comprising a first secondary controller directing a port be opened so that the first energy storage device is in electric communication with the low voltage supply line, and the first secondary controller directing the port be closed so that the first energy storage device is cut off from electric communication with the low voltage supply line.

15. The method of claim 14, comprising the first secondary controller receiving control signals from the distributor controller via the low voltage supply line.

16. The method of claim 15, comprising the first secondary controller receiving a data concerning a state of the first energy storage device and communicating the data concerning the state of the first energy storage device to the distributor controller.

17. The method of claim 16, comprising the distributor controller receiving a data concerning a state of each of the first through nth energy storage devices, and the distributor controller developing a charging schedule using the data concerning the state of each of the first through nth energy storage devices.

18. The method of claim 17, comprising the distributor controller receiving a grid data concerning a state of an electric grid, and the distributor controller determining when to execute the charging schedule based at least in part on the grid data.
